(19) United States
(12) Patent Application Publication
(10) Pub. No.: US 2025/0312942 A1
(43) Pub. Date: Oct. 9, 2025

(54) METHOD FOR LAYER-BY-LAYER DEPOSITION OF CONCRETE USING RAPIDLY HYDRATING CEMENTITIOUS MATERIAL AND BICOMPONENT CEMENTITIOUS BINDER COMPOSITION THEREFOR

(71) Applicant: Universiteit Gent, Gent (BE)

(72) Inventors: Manu Kurungod Mohan, Gent (BE); Yaxin Tao, Woluwe-Saint-Lambert (BE); Geert de Schutter, Erpe-Mere (BE); Kim van Tittelboom, Aaigem (BE); Rahul Attupurathu Vijayan, Ernakulam, Kerala (IN)

(73) Assignee: Universiteit Gent, Gent (BE)

(21) Appl. No.: 18/865,692

(22) PCT Filed: May 25, 2023
(86) PCT No.: PCT/EP2023/064031

§ 371 Date: Nov. 14, 2024

(30) Foreign Application Priority Data
May 30, 2022 (EP) 22176023.4

(51) Int. Cl. B28B 1/00; B28C 7/04; B33Y 10/00; B33Y 70/00; C04B 22/00; C04B 28/06; C04B 40/06; C04B 111/00; E04G 21/04

(52) U.S. Cl. CPC B28B 1/001; B28C 7/0413; B33Y 10/00; B33Y 70/00; C04B 22/0013; C04B 28/065; C04B 40/0658; E04G 21/0463; C04B 2111/00181

(57) ABSTRACT

The invention relates to a method for layer-by-layer deposition of concrete, in particular of concrete using a rapidly hydrating cementitious binder.

A first flow and a second flow are supplied to a mixer to obtain extrudable concrete. The pH of the second flow is larger than the pH of the first flow. The first flow comprises a retarded cementitious binder obtainable by mixing a cementitious binder with a retarder comprising boron and sodium. The retarder allows to increase the setting time of the cementitious binder and allows to influence the pH of the first flow in such a way that the pH of the first flow is lower than the pH of a flow equal to the first flow but comprising the cementitious binder instead of the retarded cementitious binder. The second flow comprises a carrier material. The volume fraction of the carrier material is at least 20 vol % of the second flow.

The present invention also relates to a bicomponent cementitious binder composition comprising a first component comprising rapidly hydrating cementitious material.

### FIELD OF THE INVENTION

The present invention relates to a method for layer-by-layer deposition of concrete by providing extrudable concrete having a high fluidity (high pumpability) before extrusion and a low fluidity (high buildability) after extrusion. In particular, the present invention relates to a method for layer-by-layer deposition of concrete using rapidly hydrating cementitious binders such as calcium sulfoaluminate cement or calcium aluminate cement.

The present invention also relates to a bicomponent cementitious binder composition comprising a first component comprising rapidly hydrating cementitious material such as calcium sulfoaluminate cement or calcium aluminate cement.

### BACKGROUND ART

Concrete is a widely used building material. In recent decades, pumping has become an indispensable technique for placing fresh concrete. Because conflicting requirements of fresh concrete exist during the pumping process where a high fluidity is required and during the post-pumping process where a high buildability is required, pumping of fresh concrete remains challenging.

On the one hand a good fluidity retention is required to obtain a good pumpability of concrete. A good fluidity retention is beneficial for decreasing pumping pressure and resuming pumping operation if a (short) interruption is experienced, for example a short interruption due to a delay of material feeding. On the other hand, excellent buildability should be reached either in formwork casting and in building methods without formwork. Buildability is defined as the material's ability to maintain its shape once extruded, for example printed, without flowing. In formwork casting a good buildability is required to avoid leakage of formworks or excessive formwork pressure during casting. This requirement is even more challenging in building methods without formwork such as extrusion-based 3D concrete printing to avoid deformation or collapse of material being extruded.

It is clear that the requirements to have a high fluidity and a good buildability are contradictory. This contradiction remains one of the biggest challenges to extrude concrete and in particular in 3D printing of concrete.

To obtain the required fluidity and buildability of concrete several kinds of Portland-based cement mixtures have been proposed. Such cement mixtures comprise accelerators such as aluminum sulfate to achieve rapid stiffening after the pumping phase. Portland-based cement mixtures have however some drawbacks. In case accelerators such as aluminum sulfate remain unmixed, durability issues can arise (due to internal sulfate attack). Furthermore, such mixtures require a very high binder content and may suffer from significant shrinkage problems and cracking. Furthermore, due to the high amount of Portland cement (PC), the CO₂ footprint of such mixtures is high.

In order to create more durable mixtures, mixtures in which Portland cement (PC) is partly replaced by calcium sulfoaluminate (CSA) cement have been proposed. Compared to PC cement, CSA cement has a much lower CO₂ footprint due to significantly lower CO₂ emission (about 50%) upon the production of CSA cement as compared to PC cement.

One of the major bottlenecks of CSA-based mixtures is their significantly low open time compared to PC cement. This is mainly due to the very short induction period as a result of the rapid hydration of CSA cement. Therefore, CSA cements require a suitable retarder to increase the open time of CSA-based mixtures to the desired level. Different retarders have been proposed to increase the open time of CSA-based mixtures. Examples of retarders comprise sodium gluconate, borax and citric acid. Mohan et al. (M. K. Mohan, A. V. Rahul, G. De Schutter, K. Van Tittelboom, Early age hydration, rheology and pumping characteristics of CSA cement-based 3D printable concrete, Constr. Build. Mater. 275 (2021) 122136) explored the feasibility of using borax (di-sodium tetraborate decahydrate, NaBa₄O₇·10H₂O) as retarder in CSA-based mixtures for layer-by-layer deposition applications.

However, because of the conflicting requirements of high fluidity and good buildability during the pumping and deposition phase, layer-by-layer deposition of such retarded CSA-based mixtures remains challenging.

Recently, methods whereby a (liquid) accelerator is added to the extrudable material at the nozzle have been proposed. WO2021/214239 describes a method for layer-by-layer deposition of concrete whereby a first flow comprising a binder material and a second flow comprising an accelerator are mixed in a static mixer to provide extrudable concrete. Although such method shows positive results using Portland-based cement as binder material of the first flow, a two phase mixing process using fast hydrating cement such as CSA-based cement remains complex. As mentioned above CSA-based cements require a suitable retarder and layer-by-layer deposition of such retarded CSA-based cement remains challenging.

CN 105384416 describes a two-component cement system with the first component comprising sulphate aluminum cement and a retarder comprising a mixture of sodium tetraborate, sodium gluconate and tartaric acid and with the second component comprising an aqueous mixture (91.5-94% mixing water) comprising lithium carbonate as accelerator. Such system has the drawback to use a mixture of multiple retarders whereby each may have a negative impact on the final properties of the end product. Furthermore, the second component comprises an aqueous mixture (91.5-94% mixing water) and thus has a low viscosity (close to 1 mPa). Because of the significant difference in viscosity between the first and the second material, the first material will result in a laminar flow, whereas the flow of the second is turbulent. Consequently, a homogeneous mixing of the components in the deposited material will not be achieved using such two-component system.

### SUMMARY OF THE INVENTION

It is an object of the present invention to provide a method to provide extrudable concrete avoiding the problems of the prior art.

It is also an object of the present invention to provide a method for layer-by-layer deposition of concrete using a fast hydrating cementitious material.

It is a further object of the present invention to provide extrudable concrete having a sufficiently high fluidity to allow pumping and a high buildability to allow the formation of structures, in particular 3D printed structures.

It is another object of the present invention to provide extrudable concrete suitable for layer-by-layer deposition at high printing speed.

It is another object of the present invention to provide an extrudable concrete by mixing a first flow and a second flow, whereby an excellent mixing homogeneity of the first flow and the second flow is obtained.

It is another object of the present invention to provide a method to provide extrudable concrete comprising no Portland cement or a low percentage of Portland cement.

It is another object of the present invention to provide a method to provide extrudable concrete having a high mechanical integrity, a lower CO₂ footprint compared Portland-based compositions, not suffering from shrinking and not requiring shrinkage reducing agents or shrinkage compensation agents.

It is a further object of the present invention to provide a method to provide extrudable concrete having a low porosity and dense microstructure.

It is a further object of the present invention to provide extrudable concrete for layer-by-layer deposition not requiring accelerators such as sulfates (for example sodium sulfate, magnesium sulfate, potassium sulfate, lithium sulfate or aluminum sulfate) and carbonates (for example sodium carbonate, magnesium carbonate, potassium carbonate or lithium carbonate) and therefore not suffering from internal sulfate attack, nor suffering from durability issues caused by such accelerators.

It is still a further object of the present invention to provide a bicomponent cementitious binder composition suitable for layer-by-layer deposition comprising a fast hydrating cementitious material as first component.

According to a first aspect of the present invention a method for layer-by-layer deposition of concrete by providing extrudable concrete and preferably continuously providing extrudable concrete is provided. The method comprises the steps of
supplying a first flow and a second flow to a mixer, preferably pumping a first flow and a second flow to a mixer.
The first flow has a first pH (pH1) and comprises a first material and optionally water. The first material comprises a retarded cementitious binder, preferably a retarded fast hydrating cementitious binder. The retarded cementitious binder is obtainable by mixing a cementitious binder with a retarder. The cementitious binder has an initial setting time T_{cem} and the retarded cementitious binder has an initial setting time T_{ret cem}.
The cementitious binder comprises preferably a fast hydrating cementitious binder. Preferred cementitious binders are binders selected from the group consisting of calcium sulfoaluminate and calcium aluminate or combinations thereof.
The retarder comprises a compound when mixed with the cementitious binder to provide the retarded cementitious binder being able to influence the initial setting time so that the initial setting time of the retarded cementitious binder T_{ret cem} is higher than the initial setting time of the cementitious binder T_{cem} and the retarder being able to influence the pH of the first flow in such a way that the first pH (pH1) of the first flow (comprising the retarded cementitious binder) is lower than the pH of a flow equal to the first flow but comprising the cementitious binder instead of the retarded cementitious binder and not comprising the retarder. The retarder comprises a compound comprising boron and sodium. Preferred retarders comprise borax (di-sodium tetraborate decahydrate, NaBa₄O₇·10H₂O).
The second flow has a second pH (pH2) and comprises a second material and optionally water. The second material has an initial setting time T2.
The second pH (pH2) is larger than the first pH (pH1) and the difference between the first pH (pH1) and the second pH (pH2) is at least 2, for example 3 or 4.
The second material comprises a carrier material, preferably a powdery carrier material. The fraction of the carrier material is at least 20 vol % of the second flow and preferably at least 20 vol % of the second material.
The second material may further comprise a pH modifier. A pH modifier can be added to reach the requirements of the second pH (pH2). In preferred embodiments the second material comprises a carrier material and a pH modifier.
The second material comprising the carrier material or comprising the carrier material and at least one pH modifier may further comprise a binder material and/or aggregate material and/or supplementary cementitious material and/or one or more additional compounds.
mixing the first flow and the second flow in the mixer to obtain a third flow comprising extrudable concrete. The third flow comprises a mixture of the first material, the second material and optionally water. The mixture of the first material and the second material has an initial setting time T3, whereby the initial setting time T3 is smaller than the initial setting time of the retarded cementitious binder T_{ret cem}. In preferred embodiments the initial setting time T3 is also smaller than the initial setting time of the cementitious binder T_{cem}.

As mentioned above, the retarded cementitious binder is obtainable by mixing a cementitious binder, preferably a fast hydrating cementitious binder with a retarder. The cementitious binder is preferably a non-retarded cementitious binder.

The initial setting time of the cementitious binder is referred to as T_{cem}. The initial setting time of the mixture, i.e. the retarded cementitious binder is referred to as T_{ret cem}.

By mixing the cementitious binder with a retarder, the initial setting time of the obtained mixture, i.e. the retarded cementitious binder is prolonged. This means that T_{ret cem} is larger, preferably substantially larger than T_{cem}. In this way a retarded or sleeping cementitious binder and thus a retarded or sleeping first material is obtained.

The term ‘initial setting time’ also referred to as ‘initial set time’ or ‘initial open time’ refers to the time elapsed between the moment water (or alkali activated solution) is added to the material or the mixture of materials to the moment at which paste starts losing its plasticity. For the purpose of this invention, the initial setting time is determined by a penetration resistance method. The initial setting time is the time period elapsed between the addition of water (or alkali activated solution) to the material or mixture of materials until the material formed reaches a penetration resistance of 3.5 N/mm².

The initial setting time T_{cem} of the cementitious binder is the time period elapsed between the moment water (or alkali activated solution) is added to the cementitious binder, i.e. the cementitious binder not being mixed and not being in contact with the retarder, to the moment the material formed reaches a penetration resistance of 3.5 N/mm². To mix the material, preferably a standard rotational mixer is used.

The cementitious binder comprises preferably a fast hydrating cementitious binder, preferably a cementitious binder having an initial setting time T_{cem} smaller than 30 minutes, for example a cementitious binder having an initial setting time T_{cem} smaller than 20 minutes, such as a cementitious binder having an initial setting time T_{cem} ranging between 10 minutes and 20 minutes.

The initial setting time T_{ret cem} of the retarded cementitious binder is the time period elapsed between the moment water (or alkali activated solution) is added to the retarded cementitious binder, i.e. the binder obtainable by mixing the cementitious binder (i.e. the non-retarded cementitious binder not being mixed and not being in contact with the retarder) and the retarder, to the moment the material formed reaches a penetration resistance of 3.5 N/mm². To mix the material, preferably a standard rotational mixer is used.

The retarded cementitious binder preferably has an initial setting time T_{ret cem} larger than 30 minutes, for example larger than 60 minutes, 90 minutes or 120 minutes. Preferably, the initial setting time of the retarder cementitious binder T_{ret cem} ranges between 60 minutes and 180 minutes.

The second initial setting time T2 is the time period elapsed from the moment water (or alkali activated solution) is added to the second material of the second flow to the moment the material formed reaches a penetration resistance of 3.5 N/mm². To mix the material, preferably a standard rotational mixer is used.

The initial setting time T2 is larger than the initial setting time of the cementitious binder T_{cem}. Preferably, the initial setting time is larger than the initial setting time of the retarded cementitious binder T_{ret cem}. More preferably, the initial setting time T2 is substantially larger than the initial setting time of the cementitious binder T_{ret cem}. The initial setting time T2 is for example at least 2 times the initial setting time T_{ret cem}. In preferred embodiments the initial setting time T2 is at least 5 times or at least 10 times the initial setting time T_{ret cem}. In particular embodiments the initial setting time T2 is at least 20 times the initial setting time T_{ret cem} or at least 40 times the initial setting time T_{ret cem}.

Preferably, the initial setting time T2 is at least 30 minutes. More preferably, the initial setting time T2 is at least 120 minutes, even more preferably, the initial setting time T2 is at least 180 minutes, at least 240 minutes, at least 300 minutes, at least 360 minutes, at least 420 minutes or at least 480 minutes.

The third initial setting time T3 is the time period elapsed between the moment water (or alkali activated solution) is added to the mixture of the first material of the first flow and the second material of the second flow to the moment the material formed reaches a penetration resistance of 3.5 N/mm². To mix the material preferably a standard rotational mixer is used.

The initial setting time T3 is smaller than the initial setting time of the retarded cementitious binder T_{ret cem}.

In preferred embodiments, the initial setting time T3 is also smaller than the initial setting time of the cementitious binder T_{cem}. In particular embodiments, the initial setting time T3 is smaller than a quarter or smaller than one tenth of the initial setting time of the cementitious binder T_{cem}.

Preferably, the initial setting time T3 ranges between 1 and 15 minutes and more preferably the initial setting time T3 ranges between 1 and 5 minutes.

Surprisingly, it has been found that by retarding a cementitious material, in particular a fast hydrating cementitious material, with a retarder according to the present invention and by combining the first flow comprising the retarded cement with a second flow having a substantially higher pH higher than the pH of the first flow, the retarded cementitious binder can be reactivated and the hydration of the retarded cementitious binder can be re-initiated allowing layer-by-layer deposition, in particular layer-by-layer deposition at high printing speed. The method according to the present invention allows to obtain a printing speed higher than 500 mm/second, for example 700 mm/second, 800 mm/second, 900 mm/second or 1000 mm/second.

The method according to the present invention does not require the presence of carbonates (for example sodium, magnesium, potassium or lithium carbonate) and sulfates (for example sodium, magnesium, potassium or lithium sulfate) either in the first flow or the second flow. This is an important advantages over systems known in the art using for example lithium carbonate as the presence of such compounds may reduce the mechanical strength at later ages.

Preferably, the first flow and the second flow are free of carbonates and sulfates.

As mentioned above the first flow has a first pH, referred to as pH1. Preferably, the first flow has a first pH (pH1) ranging between 7 and 10.

The first flow comprises a first material and optionally water. Preferably, the first flow comprises a first material and water. The volume fraction of water in the first flow is preferably equal or lower than 50 vol % of the first flow, equal or lower than 40 vol % of the first flow, equal or lower than 30 vol % of the first flow, equal or lower than 20 vol % of the first flow, for example 10 vol % of the first flow. In preferred embodiments the volume fraction of water ranges between 10 vol % and 50 vol % of the first flow, for example between 20 vol % and 50 vol % of the first flow.

The first flow can be introduced from a storage container comprising the first material and water. Alternatively, a flow of the first material is conveyed from a storage container comprising the first material towards the mixer and water and/or cementitious binder and/or aggregate material and/or supplementary cementitious material and/or one or more additional compounds such as a plasticizer or superplasticizer. Optionally, the first flow further comprises one or more (super)plasticizers. Such one or more (super)plasticizer is/are for example added to the first material (shortly) before the flow of the first material enters the inlet of the mixer.

The first material comprises the retarded cementitious binder and optionally aggregate material and/or supplementary cementitious material and/or one or more additional compounds such as one or more plasticizers and/or one or more superplasticizers.

The retarded cementitious binder is obtainable by mixing a cementitious binder with a retarder. The cementitious binder has an initial setting time T_{cem} and the retarded cementitious binder has an initial setting time T_{ret cem}, T_{ret cem} being larger than T_{cem}.

Preferred cementitious binders comprise calcium sulfoaluminate and calcium aluminate or combinations thereof.

Calcium sulfoaluminate cements are defined as cements comprising a hydraulic binder with ye'elimite (Ca₄Al₆O₁₆S or C₄A₃S) as the major phase. Calcium sulfoaluminate cement may further comprise dicalcium silicate or C₂S and tetra calcium alumina ferrite or C₄AF.

Calcium aluminate cements are defined as cements comprising predominantly hydraulic calcium aluminates, in particular monocalcium aluminate (CaAl₂O₄, CaO·Al₂O₃).

For the method according to the present invention, the choice of the retarder used to obtain the retarded cementitious binder is crucial. The retarder should allow to obtain re-activation of the retarded cementitious once the first and the second flow are mixed to provide extrudable concrete and should allow to obtain an extrudable concrete meeting the requirements of having a high pumpability and high buildability so that the extrudable concrete is suitable for layer-by-layer deposition.

The retarder should allow to influence the initial setting time of the cementitious binder so that when mixed with the cementitious binder to provide the retarded cementitious binder, the initial setting time of the retarded cementitious binder T_{ret cem} is higher than the initial setting time of the cementitious binder T_{cem}. Preferably, in addition, the retarder should allow to influence the pH of the first flow in such a way that the first pH (pH1) of the first flow (comprising the retarded cementitious binder) is lower than the pH of a flow equal to the first flow but comprising the cementitious binder instead of the retarded cementitious binder and not comprising the retarder. Preferably, the pH of the first flow (pH1) is at least one unit lower than the pH of a flow equal to the first flow but comprising the cementitious binder instead of the retarded cementitious binder and not comprising the retarder.

In an embodiment according to the present invention, the pH of the first flow comprising the retarded cementitious binder is 9.07 whereas the pH of a flow equal to the first flow but comprising the cementitious binder instead of the retarded cementitious binder and not comprising the retarder is 10.55.

Retarders used according to the present invention comprise compounds comprising boron and sodium.

A preferred compound comprising boron and sodium comprises borax (di-sodium tetraborate decahydrate, NaBa₄O₇·10H₂O).

Aggregate material comprises for example gravel, crushed stone or sand.

Supplementary cementitious material (SCM) comprises for example fly ash, slags (blast furnace slags) and/or silica fumes.

In preferred embodiments the first material comprises sand as aggregate material.

Preferably, the amount of sand is lower than 60 vol % of the material of the first flow or lower than 50 vol % of the material of the first flow.

Preferably, the amount of sand is at least 20 vol %, for example at least 30 vol % of the material of the first flow.

Preferably, the first material does not comprise Portland cement or alkali activated binder material. Preferably, the first material does not comprise the cementitious binder present in the second flow.

The second flow has a second pH referred to as pH2 and a second initial setting time referred to as T2.

Preferably, the second pH (pH2) ranges between 10 and 14. As mentioned above, the second pH (pH2) is larger than the pH of the first flow, referred to as first pH or pH1. Furthermore, the difference between the first pH (pH1) and the second pH (pH2) is at least 2 units, for example 2.5 units, 3 units, 3.5 units or 4 units.

In preferred embodiments the first pH is equal to 7 and the second pH is equal to 10. In alternative embodiments the first pH is equal to 8 and the second pH is equal to 11.

The second flow comprises a second material and optionally water. Preferably, the second material comprises a second material and water. The volume fraction of water in the second flow is preferably equal or lower than 50 vol % of the second flow, equal or lower than 40 vol % of the second flow, equal or lower than 30 vol % of the second flow, equal or lower than 20 vol % of the second flow, for example 10 vol % of the second flow. In preferred embodiments the volume fraction of water ranges between 10 vol % and 50 vol % of the second flow, for example between 20 vol % and 50 vol % of the second flow.

The second flow can be introduced from a storage container comprising the second material and water. Alternatively, a flow of the second material is conveyed from a storage container comprising the second material towards the mixer and water and/or one or more additional compounds such as aggregate material and/or one or more (super)plasticizers is/are added to the flow of the second material for example (shortly) before the flow of the second material enters the inlet of the mixer.

The second material comprises a carrier material. As specified above at least 20 vol % of the second flow, and preferably at least 30 vol %, at least 40 vol % or at least 50 vol % of the second flow comprises carrier material.

More preferably at least 20 vol % of the second material, at least 30 vol % of the second material, at least 40 vol % of the second material or at least 50% of the second material comprises carrier material.

In preferred embodiments the second material comprises a carrier material and at least one pH modifier. Optionally, the second material comprising a carrier material or a carrier material and at least one pH modifier further comprises one or more binder material and/or aggregate material and/or supplementary cementitious material and/or one or more additional compounds.

Preferably, the second material does not comprise the cementitious binder present in the first flow.

The carrier material comprises for example limestone, calcium hydroxide and/or sand.

Preferably, the carrier material or at least part of the carrier material comprises powdery carrier material.

‘Powdery material’ refers to material preferably having a particle size lower than 100 μm, lower than 80 μm or lower than 50 μm. More preferably, the average particle size of the powdery material according to the present invention is ranging between 0.1 μm and 100 μm, between 1 μm and 100 μm or between 10 μm and 100 μm. The average particle size of powdery material according to the present invention is for example ranging between 0.1 μm and 80 μm, between 0.1 μm and 50 μm, between 0.1 μm and 30 μm, between 0.1 μm and 10 μm or between 1 μm and 10 μm. The average particle size of powdery material according to the present invention is for example 3 μm, 4 μm or 5 μm.

The particle size (average particle size) can be determined by any method known in the art. A preferred method to determine the particle size (average particle size) comprises laser diffraction analysis.

Preferred powdery carrier material comprises limestone filler, such as limestone powder, mineral powder as for example sand or quartz powder or combinations thereof.

In order to obtain a mixture that is flowable and preferably also pumpable, the volume fraction of the powdery carrier material is preferably sufficiently high. In preferred embodiments, the carrier material has preferably a volume fraction of at least 20% of the second material. More preferably, the carrier material has a volume fraction of at least 30% or of at least 40% volume of the second material.

As pH modifier any compound suitable to influence the pH of the second flow (pH2) so that the pH of the second flow is larger than the pH of the first flow (pH1) can be considered.

Preferred pH modifiers comprise hydroxides such as calcium hydroxide Ca(OH)₂, sodium hydroxide NaOH and potassium hydroxide KOH.

The pH modifier is present in an amount to obtain that the second pH (pH2), i.e. the pH of the second flow is higher than the first pH (pH1), i.e. the pH of the first flow and that the difference between the second pH (pH2) and the first pH (pH1) is at least 2 units, for example 2.5 units, 3 units, 3.5 units or 4 units.

In preferred embodiments the second component comprises at least one pH modifier. More preferably, the pH modifier or pH modifiers are present in an amount ranging between 0.1 and 6 wt %, for example in an amount ranging between 0.5 and 5 wt % such as 1 wt %, 2 wt %, 3 wt % or 4 wt %. In preferred embodiments the pH modifier or pH modifiers are present in an amount ranging between 0.1 and 6 wt % of the retarded cementitious binder of the first component.

The pH modifier preferably does not comprise a salt of a weak acid as for example carbonate salts (such as sodium carbonate, sodium bicarbonate and lithium carbonate), phosphate salts (such as sodium phosphate) and salts of carboxylic acids (such as salts of acetic acid for example sodium acetate).

The binder material comprises for example a cementitious binder material, an alkali activated binder material or a combination of a cementitious binder material and an alkali activated binder material.

In case the second flow comprises binder material, such binder material is preferably present in an amount ranging between 20 and 40 vol % of the second flow and more preferably in an amount ranging between 25 and 35 vol % of the second material of the second flow.

A cementitious binder material may comprise any building material which may be mixed with a liquid, for example water, to form a plastic paste. The binder material of the second material preferably has an initial setting time larger than the initial setting time of the cementitious binder of the first material.

Cementitious binder material comprises for example cement such as Portland cement, lime and calcium sulfoaluminate cement. Cementitious material may further comprise aggregates such as gravel, crushed stone and/or sand. Cementitious material may also comprise reactive and/or non-reactive additions. Furthermore, cementitious material may comprise supplementary cementitious materials (SCMs) such as fly ash, slags (blast furnace slags) and/or silica fumes. The cementitious binder of the second material preferably has an initial setting time larger than the initial setting time of the cementitious binder of the first material. A preferred cementitious binder comprises Portland cement.

An alkali activated binder material, sometimes referred to as geopolymer binder material, comprises material having a high silica and/or alumina content that under alkaline conditions (induced by an alkali activator) forms a plastic paste. Alkali activated binder material may comprise either artificial or natural silicious and/or aluminous material. Artificial materials include for example industrial by-products such as granulated blast furnace slag, granulated phosphorus slag, ferrous and non-ferrous slag, coal fly ash, silica fumes and calcined products such as metakaolin. Natural materials comprise for example volcanic glasses such as volcanic ash, zeolites, siliceous pozzolans, diatomaceous earth.

In case the second material comprises aggregate material, such aggregate material may comprise example gravel, crushed stone or sand.

In case the second material comprises supplementary cementitious material (SCM), such supplementary cementitious material may comprise fly ash, slags (blast furnace slags) and/or silica fumes.

In case the second flow comprises aggregate material, such aggregate material is preferably present in an amount ranging between 20 and 50 vol % of the second flow, for example between 25 and 45 vol % of the second flow, for example between 30 and 35 vol % of the second flow. More preferably, aggregate material is present in an amount ranging between 20 and 50 vol % of the second material of the second flow, for example between 25 and 45 vol % of the second material of the second flow, for example between 30 and 35 vol % of the second material of the second flow.

In preferred embodiments the second flow comprises sand as aggregate material. Preferably, the amount of sand is lower than 70% volume of the material of the second flow, lower than 60% of the volume of the material of the second flow or lower than 50% volume of the material of the second flow.

The one or more additional compounds comprise for example one or more plasticizers and/or one or more superplasticizers.

In case the second flow comprises one or more additional compounds, such additional compounds are preferably present in an amount ranging between 10 and 40 vol % of the second flow, for example 20 vol %, 25 vol % or 30 vol % of the second flow. More preferably, additional compounds are present in an amount ranging between 10 and 40 vol % of the second material of the second flow, for example between 20 and 30 vol % of the second material of the second flow.

In preferred examples of the present invention the second flow comprises:
An inert filler (for example limestone or quartz powder), calcium hydroxide and water;
An inert filler (for example limestone or quartz powder), Portland cement and optionally a pH modifier (for example calcium hydroxide or sodium hydroxide);
Sand, Portland cement, optionally a pH modifier (for example calcium hydroxide or sodium hydroxide) and water;
Sand, alkali activated mixture made with precursors (for example fly ash, ground granulated blast furnace slag, copper slag, steel slag, metakaolin and blends or mixtures thereof) and an activator solution (for example sodium hydroxide, sodium silicate, sodium sulfate and blends or mixtures thereof).

The first flow and the second flow are preferably flowable (=capable of flowing). More preferably, the first flow and the second flow are flowable and pumpable (=capable of being pumped). This means that the fluidity and viscosity of the first flow and of the second flow should meet particular requirements.

The fluidity of the first and second flow is preferably sufficiently high. The term ‘fluidity’ refers the ability of materials to flow. The fluidity can be measured by a flow table test. Freshly mixed material is placed inside a cone-shaped mold in two layers. Then the mold is removed and the vibrating table is dropped 25 times in 15 seconds. The final diameter represents the fluidity of the fresh material.

The viscosity of the first flow (referred to as first viscosity V1) and the viscosity of the second flow (referred to as second viscosity V2) range preferably between 0.1 Pa·s and 60 Pa·s. More preferably, the first viscosity V1 and/or the second viscosity V2 is at least 1 Pa·s, at least 2 Pa·s, at least 3 Pa·s, at least 4 Pa·s, at least 5 Pa·s or at least 10 Pa·s. The first viscosity V1 and the second viscosity V2 is for example ranging between 1 Pa·s and 50 Pa·s or between 1 Pa·s and 40 Pa·s.

The ratio of the first viscosity V1 to the second viscosity V2, V1/V2 ranges preferably between 1/40 and 40. More preferably, the ratio V1/V2 ranges between 1/20 and 20. Even more preferably, the ratio V1/V2 ranges between 1/10 and 10, between 1/5 and 5 or between 1/2 and 2. In particular preferred embodiments the ratio V1/V2 ranges 0.7 and 1.3, for example between 0.8 and 1.2 or between 0.9 and 1.1.

The term ‘viscosity’ refers to the resistance of a fluid to deform at a given shear rate. The viscosity of the first flow, the second flow and the third flow are measured by a flow curve test, normally performed on a rotary rheometer. Most rotary rheometers work according to the Searle principle: a motor drives a geometry inside a fixed cup. The rotational speed of the bob is preset and produces the motor torque that is needed to rotate the measuring geometry. This torque has to overcome the viscous forces of the tested materials and is therefore a measure for its viscosity.

The first flow is supplied to the mixer with a flow rate F1 and the second flow is supplied to the mixer with a flow rate F2. The first flow rate F1 ranges preferably between 0.5 L/min and 100 L/min, as for example 1 L/min, 10 L/min, 20 L/min or 50 L/min. The second flow rate ranges preferably between 0.5 L/min and 100 L/min, as for example 1 L/min, 10 L/min, 20 L/min or 50 L/min.

Preferably, the ratio of the flow rate F1 over the flow rate F2, F1/F2 ranges between 1/10 and 10 and more preferably between 1/5 and 5 or between 1/2 and 2; for example 0.8, 0.9, 1, 1.1 or 1.2.

The first flow is preferably supplied to the mixer by pumping. The first flow is for example introduced to the mixer by pumping the first material and water by means of a first pump to an inlet of the mixer. The second flow is for example introduced to the mixer by pumping the second material and water by means of a second pump to an inlet of the mixer.

The first pump and the second pump can be simultaneously or not simultaneously activated. In case the first and second pump are simultaneously activated, the first pump and the second pump are working during the same time interval and are activated and deactivated at the same moment in time.

In preferred embodiments, the first and second pump are not deactivated simultaneously. In a particular embodiment, one of the first or second pump is deactivated while the other pump is still active. This way of working can be preferred to flush the mixer once the deposition process is stopped or interrupted.

The first flow is preferably introduced to a first inlet of the mixer and the second flow is preferably introduced to a second inlet of the mixer.

The first flow and the second flow are supplied to the mixer in a volume ratio first flow/second flow ranging between 10/90 and 90/10, for example in a volume ratio first flow/second flow of 20/80 or 80/20 or in a volume ratio first flow/second flow of 30/70 or 70/30.

The third flow comprises a mixture of the first material, the second material and optionally water. Preferably, the third flow comprises a mixture of the first material, the second material and water.

Optionally, the third flow further comprises one or more additional compounds.

According to a second aspect of the present invention, a bicomponent type cementitious binder composition comprising a first component and a second component is provided.

The first component and the second component are preferably present in a volume ratio first component/second component ranging between 10/90 and 90/10. In preferred embodiments the volume ratio first component/second component ranges between 20/80 and 80/20 or between 30/70 and 70/30.

The first component comprises a retarded cementitious binder obtainable by mixing a first cementitious binder and between 0.1 and 5 wt % of a retarder or a combination of retarders. The first cementitious binder is selected from the group consisting of sulfoaluminate cement, aluminate cement and combinations thereof. The retarder comprises a compound comprising boron and sodium. A preferred compound comprising boron and sodium comprises borax (di-sodium tetraborate decahydrate, NaBa₄O₇·10H₂O).

Optionally, the first component further comprises aggregate material and/or supplementary cementitious material and/or one or more additional compounds.

Preferably, the first component comprises at least 30 wt % retarded cementitious binder, for example at least 40 wt %, at least 50 wt % or at least 60 wt % retarded cementitious binder.

As mentioned above, the cementitious binder has an initial setting time T_{cem} and the retarded cementitious binder having an initial setting time T_{ret cem}, T_{ret cem} being larger than T_{cem}.

The second component comprises a carrier material and optionally a pH modifier. The volume fraction of the carrier material is preferably at least 20 vol % of the second component. More preferably the volume fraction of the carrier material is at least 30 vol %, at least 40 vol % or at least 50 vol % of the second component.

The carrier material comprises for example limestone, calcium hydroxide and/or sand.

Preferably, the carrier material or at least part of the carrier material comprises powdery carrier material. Preferably at least 20 vol % of the second component comprises a powdery carrier material. More preferably, the volume fraction of the powdery carrier material is least 30 vol %, at least 40 vol % or at least 50 vol % of the second component.

‘Powdery material’ refers to material preferably having a particle size lower than 100 μm, lower than 80 μm or lower than 50 μm. More preferably, the average particle size of the powdery material according to the present invention is ranging between 0.1 μm and 100 μm, between 1 μm and 100 μm or between 10 μm and 100 μm. The average particle size of powdery material according to the present invention is for example ranging between 0.1 μm and 80 μm, between 0.1 μm and 50 μm, between 0.1 μm and 30 μm, between 0.1 μm and 10 μm or between 1 μm and 10 μm. The average particle size of powdery material according to the present invention is for example 3 μm, 4 μm or 5 μm.

The particle size (average particle size) can be determined by any method known in the art. A preferred method to determine the particle size (average particle size) comprises laser diffraction analysis.

Preferred powdery carrier material comprises limestone filler, such as limestone powder, mineral powder as for example sand or quartz powder or combinations thereof.

In preferred embodiments the second component comprises at least one pH modifier. More preferably, the pH modifier or pH modifiers are present in an amount ranging between 0 and 6 wt % of retarded cementitious binder of the first component.

Preferably, the at least one pH modifier comprises a hydroxide for example calcium hydroxide Ca(OH)₂, sodium hydroxide NaOH or potassium hydroxide KOH.

The second component may further comprise a binder material and/or aggregate material and/or supplementary cementitious material and/or one or more additional compound.

The binder material comprises for example a cementitious binder material, an alkali activated binder material or a combination of a cementitious binder material and an alkali activated binder material. Examples of cementitious binder material and alkali activated binder material are given above.

Aggregate material comprises for example gravel, crushed stone or sand.

Supplementary cementitious material (SCM) comprises for example fly ash, slags (blast furnace slags) and/or silica fumes.

Additional compounds comprise for example plasticizes and/or superplasticizers.

In a first group of preferred embodiments the second component comprises a carrier material, a cementitious binder material and at least one pH modifier. The cementitious binder present in the second component is preferably a cementitious binder other than the cementitious binder of the first component.

The pH modifier is preferably present in an amount ranging between 0.1 wt % and 6 wt % of the retarded cementitious binder of the first component, for example in an amount of 1 wt %, 2 wt %, 3 wt %, 4 wt % or 5 wt % of the retarded cementitious binder of the first component. The second components of the first group of preferred embodiments may further comprise aggregate material and/or supplementary cementitious material and/or one or more additional components such as one or more plasticizers and/or one or more superplasticizers.

Preferred carrier material comprises an inert filler such as limestone or quartz powder. In other preferred embodiments the carrier material comprises a cementitious binder. Such cementitious binder has preferably an initial setting time that is substantially larger than the initial setting time of the first cementitious material of the first component (T_{cem}). A preferred cementitious binder of the second component comprises Portland cement.

It is clear that carrier material comprising an inert filler such as limestone or quartz powder and a cementitious binder such as Portland cement can be considered as well.

Preferred pH modifiers comprise hydroxides such as calcium hydroxide Ca(OH)₂, sodium hydroxide NaOH and potassium hydroxide KOH.

The first and the second flow preferably do not comprise salts of weak acids as for example carbonate salts (such as sodium carbonate or sodium bicarbonate), phosphate salts (such as sodium phosphate) and salts of carboxylic acids (such as salts of acetic acid for example sodium acetate).

Particular examples of this first group of second components comprise
at least 30 wt % an inert filler (for example limestone or quartz powder), between 0.1 and 6 wt % calcium hydroxide or sodium hydroxide and aggregate material (sand);
at least 20 wt % of an inert filler, Portland cement, between 0.1 and 6 wt % pH calcium hydroxide or sodium hydroxide and aggregate material (sand).

In a second group of preferred embodiments the second component comprises a carrier material (for example an inert filler) and an alkali activated binder material.

In particular the second component may comprise an alkali activated mixture (AAM) precursor in combination with an alkali activated mixture (AAM) activator.

The alkali-activated mixture precursor comprises for example fly ash, ground granulated blast furnace slag, copper slag, steel slag, metakaolin or blends and mixtures thereof. The alkali-activated mixture activator comprises for example a hydroxide, silicate, sulfate or blends or mixtures thereof. Preferred alkali activated mixture activators comprise sodium hydroxide, sodium silicate, sodium sulfate and blends or mixtures thereof.

The second components of the second group may further comprise aggregate material and/or one or more additional components such as one or more plasticizers and/or one or more superplasticizers.

The second component is preferably mixed with water or an alkali activated solution to provide the second flow.

The pH of the second flow is referred to as the second pH or pH2. Preferably, the pH of the second flow (pH2) is larger than the pH of the first flow (pH1).

Preferably, the second pH (pH2) ranges between 10 and 14. The difference between the first pH and the second pH is at 2 units, for example 2.5 units, 3 units or 4 units. In preferred embodiments the first pH is equal to 7 and the second pH is equal to 10. In alternative embodiments the first pH is equal to 8 and the second pH is equal to 11.

Aggregate material comprises for example gravel and/or crushed stone and/or sand. Supplementary cementitious material (SCM) comprises for example fly ash, slags (blast furnace slags) and/or silica fumes.

In preferred embodiments the first component comprises sand as aggregate material. Preferably, the amount of sand is lower than 60% volume of the material of the first flow or lower than 50% volume of the material of the first flow.

In preferred embodiment, the first component does not comprise Portland cement.

The first component may further comprise one or more additional components such as one or more plasticizers and/or superplasticizers.

The first component comprises preferably a flowable material.

In preferred embodiments the first component is mixed with water to provide a first flow.

The pH of the first flow is referred to as the first pH or pH1. Preferably, the pH of the first flow (pH1) ranges between 7 and 10 and is for example equal to 7.5, 8, 8.5, 9 or 9.5.

The second component is preferably mixed with water or an alkali activated solution to provide the second flow.

The pH of the second flow is referred to as the second pH or pH2. Preferably, the pH of the second flow (pH2) is larger than the pH of the first flow (pH1).

Preferably, the second pH (pH2) ranges between 10 and 14. The difference between the first pH and the second pH is at 2 units, for example 2.5 units, 3 units or 4 units. In preferred embodiments the first pH is equal to 7 and the second pH is equal to 10. In alternative embodiments the first pH is equal to 8 and the second pH is equal to 11.

### BRIEF DESCRIPTION OF THE DRAWINGS

The present invention will be discussed in more detail below, with reference to the attached drawings, in which:

FIG. 1 shows a system to extrude concrete according to the present invention;

FIG. 2 shows a schematic representation of the mixing process of the present invention;

FIG. 3 shows the stress-strain graph of example 1 compared to a conventional 3D printable concrete mixture;

FIG. 4 shows the penetration resistance of the mixtures of an example according to the present invention compared to comparative examples.

### DESCRIPTION OF EMBODIMENTS

The present invention will be described with respect to particular embodiments and with reference to certain drawings but the invention is not limited thereto but only by the claims. The drawings are only schematic and are non-limiting. The size of some of the elements in the drawing may be exaggerated and not drawn on scale for illustrative purposes. The dimensions and the relative dimensions do not correspond to actual reductions to practice of the invention.

When referring to the endpoints of a range, the endpoint values of the range are included.

When describing the invention, the terms used are construed in accordance with the following definitions, unless indicated otherwise.

The term ‘and/or’ when listing two or more items, means that any one of the listed items can by employed by itself or that any combination of two or more of the listed items can be employed.

The terms ‘first’, ‘second’ and the like used in the description as well as in the claims, are used to distinguish between similar elements and not necessarily describe a sequence, either temporally, spatially, in ranking or in any other manner. It is to be understood that the terms so used are interchangeable under appropriate circumstances.

The term ‘static mixer’ refers to devices for continuous mixing of fluid materials not using moving parts.

The term ‘dynamic mixer’ refers to devices for continuous mixing of fluid materials using moving parts.

The term ‘plasticizer’ and the term ‘superplasticizer’ refer to a chemical additive in concrete used to (1) reduce the water/cement ratio and/or (2) prevent particle agglomeration of cement particles.

The term ‘retarder’ refers to a chemical additive used to delay cement hydration and to keep a cementitious material workable. The term ‘retarder’ thus refers to a chemical additive that is slowing down the setting of cementitious material and increases the initial setting time of the cementitious material.

The term ‘accelerator’ refers to a chemical additive that contrary to retarders, accelerates the hydration reaction of the cementitious materials and thereby shortening the setting time of cementitious materials, in particular the initial setting time of cementitious material.

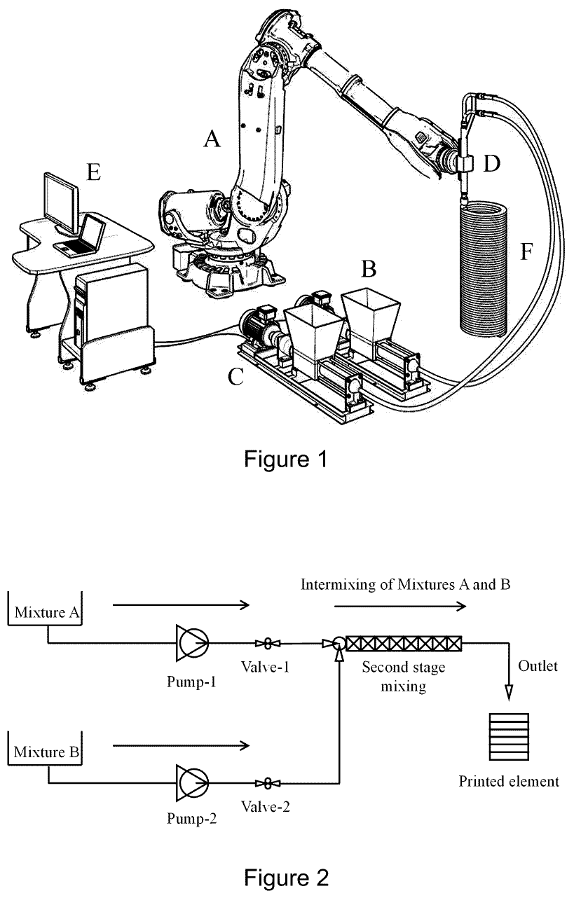

FIG. 1 shows a system to extrude concrete according to the present invention. The system comprises a six-axis industrial robot having an articulated arm A. A first flow comprising a retarded cementitious binder and water is pumped by means of a first pump B to a mixer D, for example a static or dynamic mixer. A second flow comprising a carrier material and water and having a pH higher than the pH of the first flow is pumped by means of a second pump C to the mixer D. The material of the first flow and the material of the second flow are mixed by the mixer D and the mixture is extruded from the nozzle of the deposition head of the 3D printer to form the 3D printed object F. The first pump B, the second pump C and the extruder are controlled by the controller E. The concrete is placed by robot arm A. Movements of the robot arm are controlled by controller E. Once mixed by the mixer the mixture should be sufficiently fluid to allow conveying and extrusion. On the other hand, the mixture should provide the required mechanical stability of the 3D printed object F.

Any type of mixer known in the art suitable to mix the first flow and the second flow can be considered. Both static mixers as well as dynamic mixers can be considered.

Any type of pump known in the art that is able to pump the first and/or the second flow can be considered. The pumps are preferably able to deliver high viscosity fluids with a steady flow rate. Alternatively, positive displacement pumps can be considered. In positive displacement pumps a fluid is moved by trapping a fixed amount and forcing that trapped volume into the discharge pipe. Examples of such pumps comprise progressive cavity pumps, peristaltic pumps, impulse pumps with several cavities, gear pumps, and screw pump. It is clear that other types of pumps can be considered as well.

FIG. 2 shows the mixing process of the method according to the present invention.

### EXPERIMENTAL RESULTS

### Example 1

In a first example a first flow (mixture A) and a second flow (mixture B) are prepared using the following starting materials:
Binder material: CSA cement. The specific gravity of the CSA cement is 3.15 The chemical composition of the CSA cement is given in Table 1;
Borax (di-sodium tetraborate decahydrate, Na₂B₄O₇·10H₂O);
Calcium hydroxide (CH) powder, analytical grade having a purity of more than 96% from Carl Roth chemicals;
Limestone powder;
Fine aggregates having a nominal maximum size of 2 mm, fineness modulus of 2.4 and a specific gravity of 2.65.

The compositions of the first flow (Mixture A) and of the second flow (Mixture B) are shown in Table 2. Mixture A and mixture B were prepared according to the mixing protocols shown in respectively Table 3 and Table 4.

TABLE 1
Chemical and mineralogical composition of CSA cement

| Composition | | Quantity (% by mass) |
|---|---|---|
| Oxide | CaO | 41.50 |
| | SiO₂ | 8.14 |
| | Al₂O₃ | 23.20 |
| | Fe₂O₃ | 1.05 |
| | (Na₂O)ₑ | 0.86 |
| | MgO | 3.22 |
| | SO₃ | 18.36 |
| | Loss on ignition | 1.45 |
| Phase | Ye'elimite | 54.64 |
| | Belite | 18.97 |
| | Anhydrite | 23.70 |
| | Bassanite | 0.27 |
| | Periclase | 2.40 |

TABLE 2
Mix proportions of Mixture A (CSA cement-based mixture) and
limestone-based mixtures (Mixture B) (kg/m³) of example 1

| | | CSA | Limestone | | | |
|---|---|---|---|---|---|---|
| Mixture | Sand | cement | powder | Water | Borax | Ca(OH)₂ |
| A | 1076.0 | 896.7 | 0 | 313.8 | 17.9 | 0 |
| B | 1066.8 | 0 | 847.5 | 313.8 | 0 | 41.5 |

TABLE 3
Mixing procedure for Mixture A of example 1

| Step | Process | Duration (s) |
|---|---|---|
| 1 | Add retarder to the CSA cement | — |
| 2 | Add the CSA cement + retarder to the aggregate | — |
| 3 | Dry mix at 140 rpm | 30 |
| 4 | Add water into the CSA cement + retarder + | — |
| | aggregate | |
| 5 | Mix at 140 rpm | 30 |
| 6 | Mix at 285 rpm | 60 |
| 7 | Scrape the bottom of the mixer | — |
| 8 | Continue mixing at 285 rpm | 60 |

rpm—rotations per minute

TABLE 4
Mixing procedure for mixture B of example 1

| Step | Process | Duration (s) |
|---|---|---|
| 1 | Add pH modifier to the powder material | — |
| 2 | Add pH modifier + powder material to the aggregate | — |
| 3 | Dry mix at 140 rpm | 30 |
| 4 | Add water into the pH modifier + powder material | — |
| 5 | Mix at 140 rpm | 30 |
| 6 | Mix at 285 rpm | 60 |
| 7 | Scrape the bottom of the mixer | — |
| 8 | Continue mixing at 285 rpm | 60 |

rpm—rotations per minute

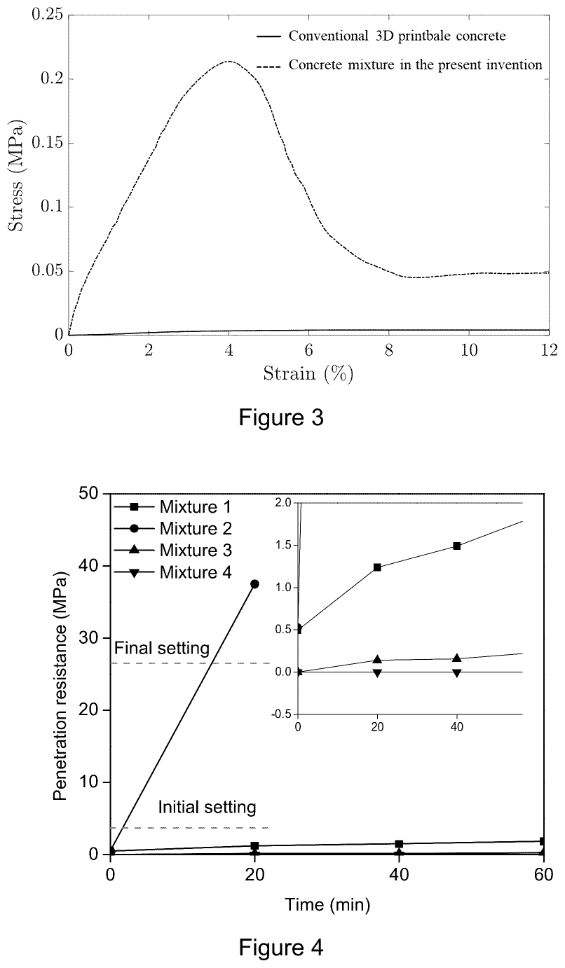

FIG. 3 shows the stress-strain graph of concrete deposited according to the method of the present invention using mixture A and mixture B as specified in example 1 compared to concrete deposited using a conventional mixture for 3D printing. The conventional mixture for 3D printing is a one component mixture not comprising an accelerator. A conventional 3D printable mixture typically has an initial setting time in the range of 60 to 90 minutes.

From FIG. 3, it is clear that the elastic modulus (slope of the stress-strain graph) and compressive strength (maximum stress from the stress-strain graph) are significantly higher for the 3D printable mixture according to the present invention as compared to a typical conventional 3D printable concrete mixture.

### Examples 2, 3 and 4

Examples 2, 3 and 4 comprising a first flow (mixture A) and a second flow (mixture B) are specified below using the following start materials:
Binder material (CSA cement), borax, calcium hydroxide (CH) powder, limestone powder, fine aggregates as specified in Example 1;
Portland cement;
Sodium gluconate;
Aluminum sulfate;
Superplasticizer (SP) polycarboxylate ether (MasterGlenium 51 from BASF);
Alkali activated mixture (AAM) precursor comprising for example fly ash, blast furnace slag, metakaolin, steel slag, or copper slag. Also blends or mixtures of these materials can be considered;
Alkali activated mixture (AAM) activator comprise for example sodium hydroxide, sodium silicate or sodium sulfate. Also blends or mixtures of these materials can be considered.

The compositions of the first flow (Mixture A) and of the second flow (Mixture B) of example 2, 3 and 4 are given in Table 5 (Example 2), Table 6 (Example 3) and Table 7 (Example 4).

TABLE 5
Mix proportions of Mixture A (CSA cement-based mixture) and Mixture
B (Portland cement-based mixture) (kg/m3) of example 2.

| | | CSA | Portland | | | Superplas- |
|---|---|---|---|---|---|---|
| Mixture | Sand | cement | cement | Water | Borax | ticizer |
| A | 1076.0 | 896.7 | 0 | 313.8 | 17.9 | 0 |
| B | 1076.0 | 0 | 896.7 | 313.8 | 0 | 5.4 |

TABLE 6
Mix proportions of Mixture A (CSA cement-based mixture) and Mixture B (Portland
cement-based mixture with calcium hydroxide) (kg/m3) of example 3

| | | CSA | Portland | | | | |
|---|---|---|---|---|---|---|---|
| Mixture | Sand | cement | cement | Water | Borax | Ca(OH)₂ | Superplasticizer |
| A | 1076.0 | 896.7 | 0 | 313.8 | 17.9 | 0 | 0 |
| B | 1076.0 | 0 | 842.9 | 313.8 | 0 | 53.8 | 5.4 |

TABLE 7
Mix proportions of Mixture A (CSA cement-based mixture)
and Mixture B (Alkali-activated mixture) (kg/m³) of
a fourth embodiment of the present invention

| | | CSA | AAM | AAM | | |
|---|---|---|---|---|---|---|
| Mixture | Sand | cement | precursor | activator | Water | Borax |
| A | 1076.0 | 896.7 | 0 | 0 | 313.8 | 17.9 |
| B | 1076.0 | 0 | 842.9 | 208.6 | 140.3 | 0 |

AAM—Alkali activated material

### Examples 5, 6, 7 and 8

The setting time of concrete obtained according to the present invention was compared with comparative examples.

In examples 5 to 8 two different mixtures (mixture A1 and mixture A2) were used as first flow and two different mixture (mixture B1 and mixture B2) were used as second flow. The mixtures were combined as shown in Table 9. The compositions of the mixtures A1, A2, B1 and B2 are shown in Table 10. The pH of the mixtures B1 and B2 is given in Table 10.

In example 5 to 8 the volume ratio of the first flow (mixture A1 or A2) to the second flow (mixture B1 or 2) is 70:30.

TABLE 9
combinations of mixtures A and B

| | First flow | Second flow |
|---|---|---|
| Example 5 | A1 | B1 |
| (comparative | | pH 10 |
| example) | | |
| Example 6 | A2 | B1 |
| (according to | | pH 10 |
| invention) | | |
| Example 7 | A1 | B2 |
| (comparative | | pH 2.46 |
| example) | | |
| Example 8 | A2 | B2 |
| (comparative | | pH 2.46 |
| example) | | |

TABLE 10
Mix proportions of mixture A1, A2, B1 and B2

Quantity (kg/m³)

| Material | A1 | A2 | B1 | B2 |
|---|---|---|---|---|
| CSA cement | 896.7 | 896.7 | — | — |
| Limestone powder | — | — | 857.0 | 857.0 |
| Aggregate | 1076.0 | 1076.0 | 1028.5 | 1028.5 |
| Borax | — | 4.48 | — | — |
| Sodium gluconate | 4.48 | — | — | — |
| Calcium hydroxide | — | — | 35.9 | — |
| Aluminum sulfate | — | — | — | 35.9 |
| Water | 313.8 | 313.8 | 300.0 | 300.0 |

The initial setting time and final setting time of the mixtures given in example 5 to 8 were measured using a penetration test whereby the initial and final setting times are determined as the times when the penetration resistance equals 3.5 MPa and 27.6 MPa. FIG. 4 shows the penetration resistance of the mixtures of example 5, 6, 7 and 8, whereby Mixture 1 represents example 5, Mixture 2 represents example 6, Mixture 3 represents example 7 and Mixture 4 represents example 8.

FIG. 4 clearly shows the ‘surprising effect’ when A2 (first flow) and mixture B1 (second flow) (denoted as mixture 2 in FIG. 4) are combined. This combined mixture exhibits a very low initial setting time, compared to other combinations shown in FIG. 4. The initial setting time T3 of the combined mixture of mixture A2 and mixture B1 is less than 5 minutes.

1. A method for layer-by-layer deposition of concrete, the method comprising providing extrudable concrete by
supplying a first flow and a second flow to a mixer,
the first flow having a first pH (pH1) and comprising a first material and optionally water, the first material comprising a retarded cementitious binder obtainable by mixing a cementitious binder with a retarder, the cementitious binder having an initial setting time Tcem and the retarded cementitious binder having an initial setting time Tret cem, with the cementitious binder being selected from the group consisting of calcium sulfoaluminate and calcium aluminate, with the retarder comprising a compound when mixed with the cementitious binder to provide the retarded cementitious binder being able to influence the initial setting time so that the initial setting time of the retarded cementitious binder Tret cem is higher than the initial setting time of the cementitious binder Tcem and with the retarder being able to influence the pH of the first flow in such a way that the first pH (pH1) of the first flow is lower than the pH of a flow equal to the first flow but comprising the cementitious binder instead of the retarded cementitious binder and not comprising the retarder, the retarder comprising a compound comprising boron and sodium;
the second flow having a second pH (pH2) and comprising a second material and optionally water, the second material having a second initial setting time (T2), with the second pH (pH2) being larger than the first pH (pH1) and with the difference between the first pH (pH1) and the second pH (pH2) being at least 2, the second material comprising a carrier material and optionally a pH modifier, with the volume fraction of the carrier material being at least 20 vol % of the second flow;
mixing the first flow and the second flow in the mixer to obtain a third flow comprising extrudable concrete, the third flow comprising a mixture of the first material, the second material and optionally water, with the mixture of the first material, the second material having an initial setting time T3, whereby the initial setting time T3 is smaller than the initial setting time of the retarded cementitious binder Tret cem.

2. The method according to claim 1, wherein the second material comprises a cementitious binder and a pH modifier and optionally a binder material and/or aggregate material and/or supplementary cementitious material and/or one or more additional compound.

3. The method according to claim 1, wherein the initial setting time T3 is smaller than the initial setting time of the cementitious binder Tcem.

4. The method according to claim 1, wherein the first pH (pH1) ranges between 7 and 10 and the second pH (pH2) ranges between 10 and 14.

5. The method according to claim 1, wherein the retarder comprises di-sodium tetraborate decahydrate.

6. The method according to claim 1, wherein the volume fraction of the carrier material is at least 20 vol % of the second material.

7. The method according to claim 1, wherein the second material comprises at least 20 vol % of a powdery carrier material having an average particle size lower than 100 μm.

8. The method according to claim 7, wherein said powdery carrier material comprises limestone powder, a mineral powder or combinations thereof.

9. The method according to claim 1, wherein the pH modifier comprises a hydroxide.

10. The method according to claim 1, wherein the binder material comprises a cementitious binder material, an alkali activated binder material or a combination of a cementitious binder material and an alkali activated binder material and/or wherein the at least one additional compound comprises a plasticizer or superplasticizer.

11. The method according to claim 1, wherein both the first and the second flow are free from carbonates and sulfates.

12. A bicomponent cementitious binder composition comprising a first component and a second component, wherein the first component comprises a retarded cementitious binder obtainable by mixing at least 30 wt % of a first cementitious binder, between 0.1 and 5 wt % of a retarder, the first cementitious binder being selected from the group consisting of sulfoaluminate cement, aluminate cement and combinations thereof, the retarder comprising a compound comprising boron and sodium,
and wherein the second component comprises a carrier material and optionally a pH modifier with the volume fraction of the carrier material being at least 20 vol % of the second component.

13. The bicomponent cementitious binder composition according to claim 14, wherein the second component further comprises a pH modifier, the pH modifier being present in an amount ranging between 0 and 6 wt % of retarded cementitious binder of the first component.

14. The bicomponent cementitious binder composition according to claim 12, wherein the pH modifier comprises a hydroxide.

15. The bicomponent cementitious binder composition according to claim 12, the second component further comprises a binder material and/or aggregate material and/or supplementary cementitious material and/or one or more additional compound.

16. The bicomponent cementitious binder composition according to claim 12, wherein the binder material of the second component comprises a cementitious binder material and the second component comprises at least one pH modifier wherein the binder material of the second component comprises an alkali activated binder material.
